(19) United States
(12) Patent Application Publication
(10) Pub. No.: US 2002/0032690 A1
(43) Pub. Date: Mar. 14, 2002

(54) Method for processing data and generating test report of test system

(76) Inventors: Yi Bo Liu, Tien Chin City (CN); Tong S. Chen, Taipei (TW); Kuang Shin Lin, Taipei (TW); Yong Zhao, Tien Chin City (CN)

Correspondence Address: SAWYER LAW GROUP LLP, P.O. Box 51418, Palo Alto, CA, 94303, US

(21) Appl. No.: 09/881,528

(22) Filed: Jun. 13, 2001

(30) Foreign Application Priority Data
Jun. 14, 2000 (TW) 89111556

(51) Int. Cl. G06F 17/30

(52) U.S. Cl. 707/104.1; 707/3; 707/10

(57) ABSTRACT

A method for processing data and generating a test report of a test system is proposed, wherein the test system used therein consists of a test client, a database server, a web server, and a report browser. The foregoing method allows a tester at the test client to transmit real-time tested data through a browser of the test client to the database server that is connected with the test client, wherein the database server is further connected with the web server is used to process and store the tested data therein. Accordingly, a viewer is allowed to search the tested data stored in the database server through the report browser connecting with the web server and to generate a test report according to his/her authorized access right to the web server and the database server. Moreover, the test report also includes integrated information of the test environment, test items and test results, and is allowed to store in the report browser for future analysis.

### FIELD OF THE INVENTION

The present invention relates to methods for processing data of test systems, and more particularly, to a method for processing data and generating a test report of a test system.

### BACKGROUND OF THE INVENTION

In a current test system, result of data after being tested is only displayed at a tester's terminal where the test is performed, that is, the tested data are not available for a person other than the tester. As a result, for generating a test report of a product, it needs to manually enter each tested datum into a database, so as to process and integrate the tested data for the report production.

The foregoing method of processing data has the following drawbacks.

1. The test report is only available for the tester who performs the test for data, but not available for other users.

2. The tested data have to be manually entered into the database for producing the test report, so that the efficiency of data integration is reduced and real-time process is not allowed for the tested data.

3. In generating the test report, test questions entered thereinto may not be totally the same as actually described in the test.

4. Information of the actual test environment (hardware and software environments) is not available.

5. The test report is not accompanied with messages of test items; that is, the real-time tested data are not available.

6. Warning or bug messages generated during performing the test are not available.

As concluded from the above-mentioned, the tested data are manually entered into the database for data integration instead of being directly processed by means of the network between the database and the terminals where the tested data are displayed. Moreover, since the tested data are manually inputted to the database, so that the real-time process for the tested data is not allowed, and only the tester who performs the test for data can view the test report of data.

Therefore, it is necessary to develop a method for processing data and generating a test report of a test system, which makes the test report accessible for a user other than a tester who performs a test for data. This method allows the tester at a test client to transmit real-time tested data through a browser to a database that is connected with the test client. The database integrally processes and stores the tested data therein. Accordingly, the user is allowed to access the tested data stored in the database through a report browser that connects with the database, so as to generate a test report thereby.

### SUMMARY OF THE INVENTION

The primary objective of present invention is to provide a method for processing data and generating a test report of a test system, allowing tested data at a test client to be transmitted through a browser to a database that is connected with the test client so as to process and store the tested data in the database, so that a user can access the tested data and generate a test report through at a report browser connected with the database.

According to the above objectives, a method for processing data and generating a test report of a test system is proposed in the invention. The test system used in the invention consists of a test client, a database server, a web server, and a report browser. The method of the invention allows the tester at test client to transmit tested data through a browser of the test client to the database server that is connected with the test client, wherein the database server is further connected with the web server is used to process and store the tested data therein. Then, a viewer can search the tested data stored in the database server by entering keywords through connection between the report browser and the web server into the database server. Accordingly, the database server generates a test report corresponding to the keywords and transmits the report to the report browser through the web server. As a result, the test report is accessible for the viewer based on his/her access right to the web server and the database server. In addition, the test report further contains information of the test environment, messages of test items, messages of test result and descriptions of test result which are integrated automatically therein, and is allowed to store in the report browser for future analysis.

### BRIEF DESCRIPTION OF DRAWINGS

The above and other objectives, features, and advantages of the present invention will become apparent from the following description when taken in conjunction with accompanying drawings which illustrate preferred embodiments of the present invention by way of examples. The contents of the accompanying drawings are described as followings:

FIG. 1 is a block diagram illustrating the basic architecture of the test system used in the method for processing data and generating the test report according to the present invention;

FIG. 2 is a flow chart illustrating the steps involved in searching the tested data and generating the test report by using the method for processing data and generating the test report of the test system according to the present invention; and

FIG. 3 is a flow diagram illustrating in detail the steps involved in obtaining the data for the test report in FIG. 2.

### DETAILED DESCRIPTION OF PREFERRED EMBODIMENTS

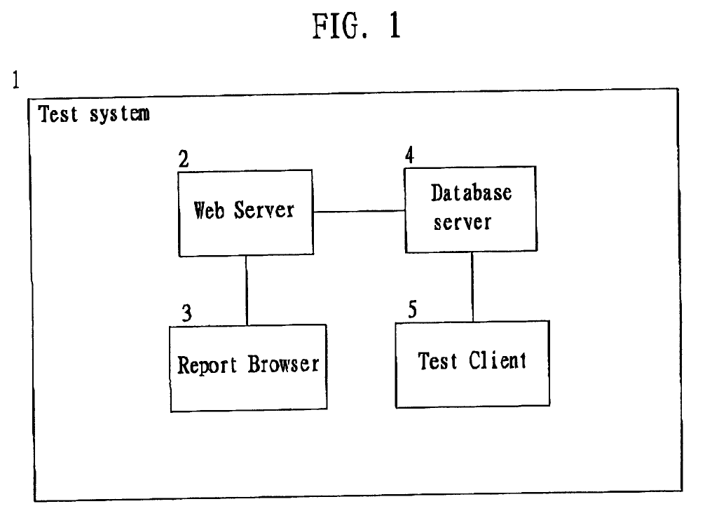

FIG. 1 is a block diagram illustrating the basic architecture of the test system used in the method for processing data and generating the test report according to the present invention. As shown in the drawing, the test system 1 consists of a web server 2, a report browser 3, a database server 4, and a test client 5. A tester at the test client 5 can transmit real-time tested data through a browser of the test client 5 to the database server 4 that is connected with the test client 5. The database server 4 is used to integrally processes and stores the tested data therein, which is further connected with the web server 2. As such, a viewer at the report browser 3, which is connected with the web server 2, can search the tested data stored in the database server 4 by means of the web server 2 connecting the report browser 3 and the database server 4. Accordingly, the preferred tested data can be accessed in such a manner that the database server 4 inputted with a keyword proceeds searching according to the keyword and reports the search result of the tested data to the report browser 3 through the web server 2, allowing the viewer to access the data shown in the report browser 3.

Different viewers are authorized with different access rights to the web server 2 and the database server 4, which determine the reports of the tested data accessible for the viewers. The reports viewed by the viewers further contain information of the test environment, messages of test items, and messages and descriptions of test results, which are integrated automatically therein, and are allowed to store in the report browser 3 for future analysis if necessary after finishing the viewing thereof.

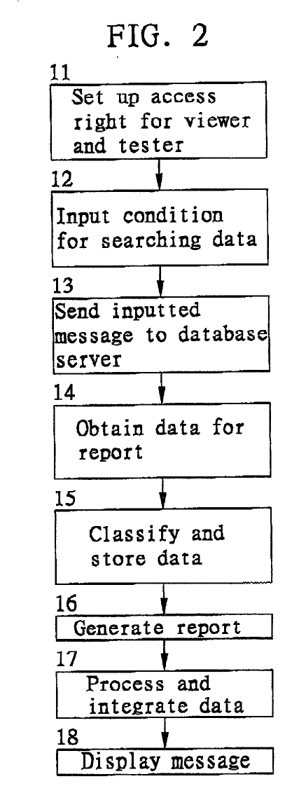

FIG. 2 is a flow chart illustrating the steps involved in searching the tested data and generating the test report by using the method for processing data and generating the test report of the test system according to the present invention. First, in step 11, in the web server 2 and the database server 4 there are set up access rights for viewers and testers, and then it moves on to step 12.

In step 12, a network is formed by connecting the report browser 3 and the web server 2, allowing the viewer at the report browser 3 to log therein. The network is further accomplished by connecting the web server 2 and the database server 4, wherein the viewer needs access rights to the web server 2 and the database server 4 to access tested data stored in the database server 4. By using the report browser 3, the viewer inputs keywords as conditions for searching the tested data, which contain information of types and plans for the test. Then, the report browser 3 transmits messages of the inputted conditions to the web server 4, and it moves on to step 13.

In step 13, upon receiving the inputted messages, the web server 2 authenticates the access right of the viewer, and transmits the inputted messages to the database server 4. It then moves on to step 14.

In step 14, the database server 4 searches and provides the tested data required for the generation of test reports according to the inputted messages and the access right of the viewer. Then, it moves on to step 15.

In step 15, the database server 4 classifies and stores the tested data obtained in step 14 on different hidden pages. For example, information about the test environment is stored on a page, information about messages of test items is stored on second page, and all the rest information of the test reports is stored on another page, wherein the page can be any type for storing or displaying the tested data, such as a web page of a browser. Then, it moves on to step 16.

In step 16, the database server 4 generates a test report formed by processing the tested data stored on the hidden pages into a preferred format. Then, it moves on to step 17.

In step 17, the database server 4 integrally processes the formatted data of the test report according to certain formula and outputs the processed data to the viewers at the report browser 3. Then, it moves on to step 18.

In step 18, the viewers at the report browser 3 can select specific cells for specific messages displayed on their browser pages according to properties of the cells. For example, the cell of test language displays in detail messages of the test environment, the cell of test items displays in detail test messages, and the cell of test results displays in detail messages of the test results.

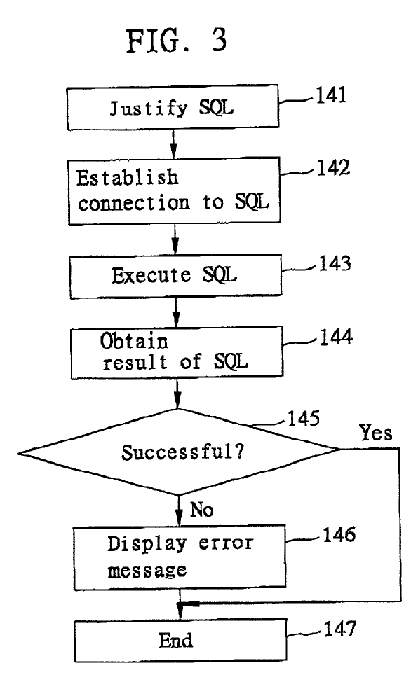

FIG. 3 is a flow diagram illustrating in detail the steps involved in obtaining the tested data for the test report in FIG. 2. As shown in the drawing, first, in step 141, it is to justify search query language (SQL) of tested data to be searched, and then moves on to step 142.

In step 142, connection between the SQL and the tested data stored in the database server 4 is established. Then, it moves on to step 143.

In step 143, the SQL is executed. Then, it moves on to step 144.

In step 144, the tested data searched by executing the SQL is obtained. Then, it moves on to step 145.

In step 145, if the search for the tested data succeeds, then it moves on to step 147; otherwise, it moves on to step 146.

In step 146, an error message is displayed for failure of the search. Then, it moves on to step 147.

In step 147, the search comes to end.

As concluded from the above-mentioned, the method for processing data and generating the test report of the test system is applicable to the test system including a test client, a database server, a web server, and a report browser, allowing a tester at the test client transmits real-time tested data through a browser of the test client to the database server that is connected with the test client. The database server, which is further connected with the web server, can process and store the tested data therein. Viewers can search the tested data stored in the database server by inputting keywords through the report browser to the database server. Accordingly, the database server generates test reports corresponding to the keywords and transmits the test reports to the report browser through the web server, allowing the test reports to be accessed by the viewers based on their access rights to the web server and the database server. The reports viewed by the viewers further contain information of the test environment, messages of test items, and messages and descriptions of test result, which are integrated automatically therein, and are allowed to store in the report browser for future analysis if necessary after the viewing thereof.

The method for processing data and generating the test report of the test system of the invention has the following advantages. First, real-time tested data can be transmitted by a tester at the test client through a browser to the database server, allowing real-time process and storage of the data to be performed by the database server. Moreover, the tested data stored in the database server can be accessed and test reports can be accordingly generated by viewers according to their authorized access rights to the web server and the database server through the report browser.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for processing data and generating a test report of a test system, which is applied to the test system consisting of a test client, a database server, a web server and a report browser, the method comprising the steps of:
a) inputting by a viewer at the report browser conditions for searching data undergoing a test through the report browser to the database server where the tested data are stored therein, wherein the inputted conditions are used for generating test reports including information of types and plans performed in the test;
b) causing the database server to search the tested data required for generating the test reports according to the inputted conditions and access right of the viewer;
c) causing the database server to classify the searched result of the tested data and store the data on different hidden pages accordingly;
d) formatting the data stored on the hidden pages for forming the test reports via the database server;
d) integrally processing the data according to certain formula and outputting the processed data to the viewer at the report browser via the database server; and
f) selecting specific cells on a page of the report browser by the viewer at the report browser for representing specific information according to properties of the cells.

2. The method for processing data and generating the test report of the test system of claim 1, wherein step (b) of causing the database server to search further comprises the steps of:
(b1) justifying search query language (SQL) of the tested data to be searched;
(b2) establishing connection between the SQL and the tested data stored in the database server;
(b3) executing the SQL;
(b4) obtaining searched result for the execution of the SQL;
(b5) determining if the searched result of the SQL execution is correct and taking corresponding actions; and
(b6) ending the search.

3. The method for processing data and generating the test report of the test system of claim 2, wherein the determining step (5) further comprises the steps of:
(b5i) displaying no error message if the searched result of the SQL execution is correct; and
(b5ii) displaying error message if the SQL execution is not successful.

4. A method for processing data and generating a test report of a test system, which is applied to the test system consisting of a test client, a database server, a web server, and a report browser, and allows viewers to search real-time tested data stored in the database server and to generate test reports according to their authorized access rights to the web server and the database server; the method comprising the steps of:
a) setting up access rights for a plurality of viewers and testers in the web server and database server;
b) forming a network by connecting the report browser and the web server and logging in the network by the plurality of viewers followed by connecting the web server to the database server by the report browser, thereby allowing the viewers to input conditions for searching tested data for generating test reports according to the inputted conditions; wherein the test reports include information of types and plans for the test of data and the report browser is capable of transmitting the inputted conditions to the web server;
c) causing the web server to authenticate the access rights of the viewers for the web server to then transmit the inputted messages to the database server receiving inputted messages of the conditions;
d) searching the tested data required for generating the test reports according to the inputted messages and the access rights of the plurality of viewers via the database server;
e) classifying and storing the data on different hidden pages via the database server;
f) processing the data on the hidden pages according to preferred forma via the database server;
g) processing the data according to certain formula and outputting the processed data to the viewers at the report browser via the database server; and
h) selecting specific cells on a page of the report browser by the viewers at the report browser for displaying specific messages according to properties of the cells.

5. The method for processing data and for generating the test report of the test system of claim 4, wherein the searching step (d) further comprises the steps of:
d1) justifying search query language (SQL) of the tested data to be searched;
d2) establishing connection between the SQL and the tested data stored in the database server;
d3) executing the SQL;
d4) obtaining searched result for the execution of the SQL;
d5) determining if the searched result of the SQL execution is correct and taking corresponding actions; and
d6) ending the search.

6. The method for processing data and generating the test report of the test system of claim 5, wherein the determining step (d5) further comprises the steps of:
d5i) displaying no error message if the searched result of the SQL execution is correct; and
d5ii) displaying error message if the SQL execution is not successful.
